(19) United States
(12) Patent Application Publication
(10) Pub. No.: US 2022/0025562 A1
(43) Pub. Date: Jan. 27, 2022

(54) COMPOSTABLE NONWOVEN WITH LOW EXTENSIBILITY

(71) Applicant: The Clorox Company, Oakland, CA (US)

(72) Inventors: Jason White, Pleasanton, CA (US); Marcus D. Cole, Pleasanton, CA (US)

(21) Appl. No.: 17/374,420

(22) Filed: Jul. 13, 2021

Related U.S. Application Data
(60) Provisional application No. 63/056,215, filed on Jul. 24, 2020.

(51) Int. Cl. D04H 3/16; A47L 13/17; D04H 3/015; C11D 17/04; C11D 1/62

(52) U.S. Cl. CPC D04H 3/16; A47L 13/17; D04H 3/015; D10B 2331/04; C11D 1/62; D10B 2321/08; D10B 2509/00; C11D 17/049

(57) ABSTRACT

Pre-dosed wipes and packaged systems of such wipes including a nonwoven substrate formed from natural pulp fibers and synthetic thermoplastic binder fibers comprising at least one of a biodegradable and/or compostable polyester, polyvinyl alcohol (PVOH), or polyvinyl acetate (PVA). The binder fibers, and the nonwoven substrate as a whole may meet any applicable biodegradability/compostability standard (e.g., ASTM D6400 or EN13432). The wipe may be substantially void of PLA. The fibers and/or nonwoven substrate may be meltblown, spunbond, spunlaid, SMS (spunbond-meltblown-spunbond), coformed, carded web, thermal bonded, thermoformed, spunlace, hydroentangled, hydroembossed, needled, or chemically bonded. A cleaning composition is loaded onto the wipe. A container can be provided within which the plurality of nonwoven substrates pre-dosed with the cleaning composition are packaged.

### CROSS REFERENCE TO RELATED APPLICATIONS

The present application claims the benefit of U.S. Provisional Patent Application Ser. No. 63/056,215, filed on Jul. 24, 2020, the disclosure of which is incorporated by reference in its entirety.

### BACKGROUND OF THE INVENTION

### 1. The Field of the Invention

The present invention relates to cleaning wipes, e.g., pre-loaded cleaning wipes that are formed from single or multi-layer substrates, and which are pre-loaded during manufacture with a cleaning composition. Such pre-loaded wipes may be provided within a container (e.g., packaged therein during manufacture).

### 2. Description of Related Art

Numerous cleaning wipes are available, e.g., such as CLOROX DISINFECTING WIPES. While such wipes provide good overall cleaning and disinfection characteristics, versatility, and convenience, there is a continuing need for improved cleaning wipes, as well as methods for their manufacture.

For example, a significant portion of the nonwoven substrate used in manufacturing such existing wipes is formed from materials sourced from non-renewable, petrochemical sources, where such materials (e.g., polypropylene and/or PET) are not typically biodegradable or compostable. As such wipes are typically used a single time and then disposed of, it would be advantageous for such substrates to be formed from materials that are renewable, and/or where such materials are biodegradable and/or compostable, reducing their environmental impact.

### BRIEF SUMMARY

The present invention relates to pre-loaded wipes that may typically be pre-loaded with a cleaning composition during manufacture, where the wipe includes a nonwoven substrate comprising natural fibers and synthetic thermoplastic binder fibers comprising at least one of a degradable, biodegradable or compostable polyester, polyvinyl alcohol (PVOH), or polyvinyl acetate (PVA), including any copolymer or polymer blend and any mixtures thereof, and a cleaning composition loaded onto the nonwoven substrate.

The nonwoven substrate is a fibrous nonwoven, e.g., such as a substrate that is a meltblown, spunbond, spunlaid, SMS (spunbond-meltblown-spunbond), coform, airlaid, wetlaid, carded web, thermal bonded, through-air bonded, thermoformed, spunlace, hydroentangled, hydroembossed, needled, chemically bonded, or combinations thereof. Nonwoven materials made of natural fibers, particularly those formed by spunlace, exhibit high levels of extensibility, particularly in the cross-direction (i.e., perpendicular to the machine direction). In traditional spunlace, synthetic petrochemically derived thermoplastic materials (e.g., such as polypropylene or PET) are used, and undergo some melting in the drying operation of such a spunlace process, which decreases the high extensibility that may otherwise be exhibited by the natural fibers. Replacing the traditional polypropylene or PET with the presently contemplated synthetic biodegradable and/or compostable binder fibers not only allows the nonwoven substrate to meet applicable biodegradability or compostability standards, for example, ASTM D6400, (e.g., D6400-19) or EN13432 (e.g., EN13432:2000), as substantially all components included therein may be biodegradable and/or compostable, but may also advantageously result in enhanced low extensibility of the nonwoven substrate, because of the presence of the contemplated biodegradable and/or compostable binder fibers, and the absence of more traditional petrochemically derived binder fibers.

The natural fibers (e.g., pulp fibers) and the synthetic binder fibers may be provided as distinct layers (e.g., with top and bottom synthetic binder layers, and a middle pulp layer), or provided relatively homogeneously blended together. In addition to the different fiber materials, a cleaning composition is provided, loaded onto the nonwoven substrate. In an embodiment, portions of the thermoplastic fibers may be melted or at least melt-softened (e.g., as a result of heating, but perhaps not to the resin's melting point), so as to bond the nonwoven structure together. In such embodiments, no additional adhesive may be present to hold the various fibers, or layers of fibers, together.

In an embodiment, the contemplated synthetic degradable, biodegradable or compostable binder fibers may include at least one of biodegradable or compostable polyesters, polyvinyl alcohol (PVOH), or polyvinyl acetate (PVA), including any copolymer or polymer blend and any mixtures thereof. Examples of biodegradable or compostable polyesters include, but are not limited to, polyhydroxyalkanoate (PHA), or polylactic acid (PLA), and any copolymer or polymer blend and any mixtures thereof, although in some embodiments, the nonwoven substrate may be void or substantially void of PLA.

Another embodiment is directed to a pre-loaded wipe comprising a nonwoven substrate as described above, e.g., comprising natural (e.g., pulp) fibers and synthetic binder fibers comprising at least one of a degradable, biodegradable or compostable polyester, polyvinyl alcohol (PVOH), or polyvinyl acetate (PVA) and any copolymer or polymer blend and any mixtures thereof, where the nonwoven substrate is at least one of meltblown, spunbond, spunlaid, SMS (spunbond-meltblown-spunbond), coform, airlaid, wetlaid, carded web, thermal bonded, through-air bonded, thermoformed, spunlace, hydroentangled, hydroembossed, needled, or chemically bonded. A cleaning composition comprising an antimicrobial sanitizing or disinfecting compound is provided pre-loaded on the nonwoven substrate, during manufacture. Suitable antimicrobial compounds include, but are not limited to, quaternary ammonium compounds, organic acids (e.g. citric, lactic, glycolic, etc.), phenolic compounds (e.g. thymol, limonene, terpineol, etc.), hydrogen peroxide and polyacrylic acid and any mixture or combinations thereof.

Another embodiment is directed to a pre-loaded wipe system comprising a plurality of nonwoven substrates as described above, e.g., comprising natural (e.g., pulp) fibers and synthetic thermoplastic binder fibers comprising at least one of polyhydroxyalkanoate (PHA), polyvinyl alcohol (PVOH), or polyvinyl acetate (PVA), and any copolymer or polymer blend and any mixtures thereof, where the nonwoven substrate is void or substantially void of PLA, where the nonwoven substrate is at least one of meltblown, spunbond, spunlaid, SMS (spunbond-meltblown-spunbond), coform, airlaid, wetlaid, carded web, thermal bonded, through-air bonded, thermoformed, spunlace, hydroentangled, hydroembossed, needled, or chemically bonded, and any combinations thereof. A cleaning composition comprising an antimicrobial compound is provided pre-loaded on the nonwoven substrate, during manufacture, and the pre-loaded nonwoven substrates are provided packaged within a dispensing container (e.g., a flex pack, cylinder, tub, or other dispensing container). Suitable antimicrobial compounds include, but are not limited to, quaternary ammonium compounds, organic acids (e.g. citric, lactic, glycolic, etc.), phenolic compounds (e.g. thymol, limonene, terpineol, etc.), hydrogen peroxide and polyacrylic acid and any mixture or combinations thereof.

Further features and advantages of the present invention will become apparent to those of ordinary skill in the art in view of the detailed description of preferred embodiments below.

### DETAILED DESCRIPTION OF THE PREFERRED EMBODIMENTS

### I. Definitions

Before describing the present invention in detail, it is to be understood that this invention is not limited to particularly exemplified systems or process parameters that may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

The term “comprising” which is synonymous with “including,” “containing,” or “characterized by,” is inclusive or open-ended and does not exclude additional, unrecited elements or method steps.

The term “consisting essentially of” limits the scope of a claim to the specified materials or steps “and those that do not materially affect the basic and novel characteristic(s)” of the claimed invention.

The term “consisting of” as used herein, excludes any element, step, or ingredient not specified in the claim.

It must be noted that, as used in this specification and the appended claims, the singular forms “a,” “an” and “the” include plural referents unless the content clearly dictates otherwise. Thus, for example, reference to a “thermoplastic material” includes one, two or more thermoplastic materials.

Unless otherwise stated, all percentages, ratios, parts, and amounts used and described herein are by weight.

Numbers, percentages, ratios, or other values stated herein may include that value, and also other values that are about or approximately the stated value, as would be appreciated by one of ordinary skill in the art. As such, all values herein are understood to be modified by the term “about”. Such values thus include an amount or state close to the stated amount or state that still performs a desired function or achieves a desired result. A stated value should therefore be interpreted broadly enough to encompass values that are at least close enough to the stated value to perform a desired function or achieve a desired result, and/or values that round to the stated value. The stated values include at least the variation to be expected in a typical manufacturing or other process, and may include values that are within 10%, within 5%, within 1%, etc. of a stated value.

Some ranges may be disclosed herein. Additional ranges may be defined between any values disclosed herein as being exemplary of a particular parameter. All such ranges are contemplated and within the scope of the present disclosure.

In the application, effective amounts are generally those amounts listed as the ranges or levels of ingredients in the descriptions, which follow hereto. Unless otherwise stated, amounts listed in percentage (“%'s”) are in weight percent (based on 100% active) of any composition.

The phrase ‘free of’ or similar phrases if used herein means that the composition or article comprises 0% of the stated component, that is, the component has not been intentionally added. However, it will be appreciated that such components may incidentally form thereafter, under some circumstances, or such component may be incidentally present, e.g., as an incidental contaminant.

The phrase ‘substantially free of’ or similar phrases as used herein means that the composition or article preferably comprises 0% of the stated component, although it will be appreciated that very small concentrations may possibly be present, e.g., through incidental formation, contamination, or even by intentional addition. Such components may be present, if at all, in amounts of less than 1%, less than 0.5%, less than 0.25%, less than 0.1%, less than 0.05%, less than 0.01%, less than 0.005%, less than 0.001%, or less than 0.0001%. In some embodiments, the compositions or articles described herein may be free or substantially free from any specific components not mentioned within this specification.

As used herein, “disposable” is used in its ordinary sense to mean an article that is disposed or discarded after a limited number of usage events, preferably less than 25, more preferably less than about 10, and most preferably after a single usage event. The wipes disclosed herein are typically disposable.

As used herein, the term “substrate” is intended to include any material that is used to clean an article or a surface. Examples of cleaning substrates include, but are not limited to, wipes, mitts, pads, or a single sheet of material which is used to clean a surface by hand or a sheet of material which can be attached to a cleaning implement, such as a floor mop, handle, or a hand held cleaning tool, such as a toilet cleaning device. The term “substrate” is also intended to include any material that is used for personal cleansing applications. These substrates can be used for hard surface, soft surface, and personal care applications. Such substrates may typically be in the form of a wipe.

Such substrates may be formed of a structure of individual fibers which are interlaid, typically in a manner that is not identifiable (e.g., a nonwoven). The nonwoven substrates, or layers used to make up such a nonwoven substrate included in the present substrates may be formed by any suitable process. For example, they may be meltblown, spunbond, spunlaid, SMS (spunbond-meltblown-spunbond), coformed, carded webs, thermal bonded, thermoformed, spunlace, hydroentangled, hydroembossed, needled, or chemically bonded. Various processes for forming such nonwovens will be apparent to those of skill in the art, many of which are described in U.S. Pat. No. 7,696,109, incorporated herein by reference in its entirety. EP Applications EP992338, EP1687136, EP1861529, EP1303661, and US2004/0157524 are also herein incorporated by reference, each in its entirety. These references describe various nonwoven structures which are generally illustrative, and which may be modified by using the contemplated biodegradable and/or compostable synthetic binder fibers rather than the synthetics typically employed in the prior art.

The terms “wipe”, “substrate” and the like may thus overlap in meaning, and while “wipe” may typically be used herein for convenience, it will be appreciated that this term may often be interchangeable with “substrate”.

As used herein, “wiping” refers to any shearing action that the wipe undergoes while in contact with a target surface. This includes hand or body motion, substrate-implement motion over a surface, or any perturbation of the substrate via energy sources such as ultrasound, mechanical vibration, electromagnetism, and so forth.

The cleaning compositions dosed onto the substrate as described herein may provide sanitization, disinfection, or sterilization, other cleaning, or other treatment. As used herein, the term “sanitize” shall mean the reduction of “target” contaminants in the inanimate environment to levels considered safe according to public health ordinance, or that reduces a “target” bacterial population by significant numbers where public health requirements have not been established. By way of example, an at least 99% reduction in bacterial population within a 24 hour time period is deemed “significant.” Greater levels of reduction (e.g., 99.9%, 99.99%, etc.) are possible, as are faster treatment times (e.g., within 10 minutes, within 5 minutes, within 4 minutes, within 3 minutes, within 2 minutes, or within 1 minute), when sanitizing or disinfecting.

As used herein, the term “disinfect” shall mean the elimination of many or all “target” pathogenic microorganisms on surfaces with the exception of bacterial endospores.

As used herein, the term “sterilize” shall mean the complete elimination or destruction of all forms of “target” microbial life and which is authorized under the applicable regulatory laws to make legal claims as a “sterilant” or to have sterilizing properties or qualities.

Some embodiments may provide for at least a 2 or more log reduction (e.g., 3-log reduction, or 6-log reduction) in a bacterial population within a designated time period (e.g., 10 minutes, 5 minutes, 4 minutes, 3 minutes, 1 minute, 30 seconds, 10 seconds or the like). A 2-log reduction is equivalent to a 99% reduction, a 3-log reduction is equivalent to at least a 99.9% reduction, a 4-log reduction is equivalent to at least a 99.99% reduction, a 5-log reduction is equivalent to at least a 99.999% reduction, etc. An example of a target microbe may be Staphylococcus aureus. It will be appreciated that microefficacy can also be achieved against other target microbes, numerous examples of which will be apparent to those of skill in the art. It will also be appreciated that the present cleaning compositions need not include an antimicrobial agent (e.g., a quaternary ammonium compound, bleach or the like), where sanitization or disinfection is not necessarily desired.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

### II. Exemplary Nonwoven Substrates

In an aspect, the present invention is directed to pre-loaded nonwoven substrates, where they are specifically formed from materials that are more environmentally friendly as compared to the non-biodegradable, non-compostable materials typically employed as synthetic fibers in such wipes. The structure of the wipe may be such that the natural (e.g., pulp) fibers and the synthetic thermoplastic binder fibers are provided in generally separate layers (e.g., synthetic thermoplastic binder layers at top and bottom, with pulp fibers sandwiched between), or with all such fibers simply blended together, e.g., in a substantially homogenous distribution of the various fiber components. The fibers and/or nonwoven may be formed by any suitable technique, e.g., including but not limited to meltblown, spunbond, spunlaid, SMS (spunbond-meltblown-spunbond), coform, carded webs, thermal bonded, thermoformed, spunlace, hydroentangled, hydroembossed, needled, or chemically bonded, and any combinations thereof. In an embodiment, the nonwoven may be spunlace.

In one embodiment, the nonwoven substrate may be comprised of multiple layers (e.g., 2 or 3 layers). For example, top and bottom exterior surface layers that may be formed from or at least include the environmentally friendly synthetic thermoplastic fibers, with the natural pulp fibers (e.g., plant-based, structured fibers) present as an interior layer between the synthetic exterior layers. In an embodiment, the exterior layers could comprise a blend of the synthetic fibers and the pulp fibers. The thermoplastic synthetic fibers can be melted or at least heat softened during formation of the nonwoven (e.g., through a calendaring step), or the different layers or different fiber types can be bonded to one another through other techniques, e.g., hydroentangling, needling or any other technique. Even with hydroentangling, hydroembossing, or spunlace, some melting or at least melt softening may occur during a drying step of such processes.

In an embodiment, the top and bottom exterior layers may serve to adhere the entire multi-layer substrate together in a single mass, with low risk of delamination, while providing desired characteristics relative to hand-feel and stiffness (as a result of the biodegradable and/or compostable thermoplastic fibers in the exterior layers), as well as desired absorbency characteristics (ability to load the substrate to a desired loading ratio with a cleaning composition). Where the thermoplastic fibers are melted or melt softened in contact with the natural pulp fibers, the melt softened thermoplastic fibers may encapsulate, envelope, wrap, or otherwise coat individual adjacent fibers of the natural fibers, providing a strong bond between the two, such that delamination does not readily occur. This also can decrease the otherwise very high extensibility of the pulp fibers, due to them becoming at least somewhat bound by the melt softened thermoplastic binding fibers. When thermoplastic fibers are melted or soften and combined with natural pulp fibers, a substrate with a desirable range of extensibility may be formed. The desirable range of extensibility for these substrates, in the cross direction, is less than 80%, less than 70%, less than 60%, between about 30% and 70%, between about 35% and 60% and between about 40% and 50%. In one embodiment, a substrate formed by combining melted thermoplastic fibers and pulp fibers which has less than 10% extensibility in the machine direction and between about 40% and 50% extensibility in the cross direction.

While a 3-layer structure may be advantageous for providing the same hand-feel and stiffness characteristics to both faces of the wipe, it is also within the scope of the invention to provide a 2 layer structure, where one face may be comprised primarily of the synthetic fibers, and the other face may be comprised primarily of the natural fibers. Of course, in another embodiment, the fibers may be substantially homogenously mixed within a single layer structure. In an embodiment, bonding of individual layers or different fiber types into an integral, single substrate structure is provided without the need for any chemical adhesives.

No matter the process by which the dry nonwoven substrate is formed, once, formed, a desired cleaning composition may be loaded onto the nonwoven substrate.

Various thermoplastic polymers exhibiting biodegradability and/or compostability characteristics may be used as binder fibers in forming the present nonwoven substrates. While polyethylene, polypropylene, PET, PVC, polyacrylics, polyamides, polystyrenes, or the like may have been used in the past as synthetic binder fibers, many if not all such materials are not biodegradable or compostable to any significant extent, within a reasonable time frame (e.g., 5 years or less), and as such, are avoided in the present invention. Biodegradability and/or compostability is defined herein as meeting an applicable standard, such as ASTM D6400 or EN13432. Rather, the present invention contemplates using thermoplastic materials such as certain polyesters, polyvinyl alcohols, or polyvinyl acetates that advantageously do exhibit biodegradability and/or compostability.

The natural fibers may comprise any of various natural fibers. In an embodiment, such natural fibers may comprise pulp fibers (e.g., wood pulp). Non-limiting examples of other natural fibers include, but are not limited to cellulose fibers, regenerated cellulose fibers (e.g., viscose, lyocell, and/or rayon), and cotton. Such natural fibers may typically be of shorter length than the synthetic binder fibers.

The basis weight of the nonwoven substrates or individual layers thereof may be expressed in grams per square meter (gsm), and may be, for example, no more than 200 gsm, no more than 100 gsm, such as from 5 to 80 gsm, or from 10 to 60 gsm.

It will be appreciated that the present wipes may include any of various textures, or perhaps no texture at all. Various textures are shown in FIGS. 1A-1D and FIGS. 7A-7F as described in Applicant's U.S. application Ser. No. 16/710,676 filed on Dec. 11, 2019, bearing Attorney Docket No. 510.186A herein incorporated by reference in its entirety.

The thermoplastic binder fibers used in the present nonwoven substrates are formed from a material that comprises synthetic fibers. In an embodiment, the binder fibers may be present as an exterior layer (e.g., both top and bottom exterior layers) of the nonwoven substrate. Various biodegradable and/or compostable nonwoven materials may be used, rather than traditionally employed non-biodegradable resin materials, such as polypropylene and/or PET. According to the present embodiments, the binder fibers may specifically comprise or be formed from a biodegradable or compostable polyester, such as polyhydroxyalkanoate (PHA), polyvinyl alcohol (PVOH), which is also biodegradable and/or compostable, or polyvinyl acetate (PVA), which is also biodegradable and/or compostable. While polylactic acid (PLA) is an example of biodegradable polyester, in an embodiment, substantially no PLA fibers are present. For example, while PLA fibers can be compostable, at least some of the above mentioned materials exhibit improved biodegradability and/or compostability as compared to PLA.

Such fibers and nonwovens may be formed by any suitable processes, including, but not limited to meltblown, spunbond, spunlaid, SMS (spunbond-meltblown-spunbond), coform, carded webs, thermal bonded, thermoformed, spunlace, hydroentangled, hydroembossed, needled, or chemically bonded. In an embodiment, an exterior layer comprising the biodegradable and/or compostable synthetic thermoplastic fibers may also incorporate a fraction of pulp fibers therein (e.g., as a homogenous blend of randomly distributed synthetic and pulp fibers, or where the pulp fibers are positioned non-randomly, e.g., at an exterior, or at an interior surface). In any case, the fraction of biodegradable/compostable synthetic thermoplastic fibers within the top and/or bottom exterior surface layer may be at least 50%, at least 60%, at least 70%, at least 80%, at least 90%, or at least 95%, by weight, of the fibers present in a given layer. In an embodiment, 100% of the fibers in a given exterior surface layer may be the particular biodegradable and/or compostable thermoplastic synthetic fibers.

Similarly, where a distinct natural fiber layer is employed, the natural fiber layer may comprise at least 50%, at least 60%, at least 70%, at least 80%, at least 90%, or at least 95%, by weight of the natural fibers. In an embodiment, 100% of fibers in a natural fiber layer may be natural fibers.

While a wide variety of synthetic materials are sometimes used as binder fibers, e.g., most typically polypropylene and/or PET, these materials are not biodegradable or compostable, as defined by ASTM D6400, or EN13432. Advantageously, the nonwoven substrate may consist essentially of the biodegradable and/or compostable binder fibers and the pulp fibers, so that the wipe as a whole meets such biodegradability/compostability standards. In an example, the wipe may be free of, or substantially free of fibers that do not meet such standards, i.e., free of polyethylene, polypropylene, PET, PVC, polyacrylics, polyamides, polystyrenes, or the like.

Individual layers, or the nonwoven substrate as a whole may have a basis weight of no more than 200 gsm, no more than 100 gsm, such as from 5 to 80 gsm, or from 10 to 60 gsm.

The selected biodegradable and/or compostable thermoplastic material may advantageously have a melting temperature that is less than 300° C., less than 275° C., less than 250° C., at least 100° C., at least 150° C., at least 175° C., or at least 200° C., such as from 200-250° C., or from 210-240° C. Having a relatively lower melting temperature reduces energy requirements needed in any calendaring process or other process that achieves bonding or reduced extensibility through melt softening. Where any pulp fiber content is included in a layer or multilayer nonwoven substrate being calendared or otherwise thermally treated, it may be advantageous that the synthetic thermoplastic binder material have a melting temperature sufficiently low to ensure that any pulp fibers do not ignite, or become embrittled or discolored due to “burning”, which may occur near the paper ignition temperature of 233° C. As such, selection of relatively lower melting temperature thermoplastic binder materials may be preferred, so long as they can provide a good bond to the various fibers included in the substrate as a whole.

The selected biodegradable and/or compostable thermoplastic binder fibers may have a glass transition temperature of at least 0° C., at least 25° C., at least 50° C., or at least 75° C., but less than 200° C., less than 175° C., less than 150° C., less than 125° C., or less than 100° C., such as from 50° C. to 100° C., or from 60° C. to 90° C., or from 70° C. to 90° C.

The selected biodegradable and/or compostable thermoplastic binder fibers may exhibit crystallinity of at least 30%, at least 40%, or at least 50%, less than 80%, less than 70%, from 40-70%, or from 50-65%, for example. Determination of glass transition temperatures, melting temperatures, and crystallinity may be determined by differential scanning calorimetry (DSC).

Table 1 shows exemplary characteristics obtained through thermogravimetric analysis (TGA) and differential scanning calorimetry (DSC) for an exemplary PVOH material. The sample PVOH substrates in Table 1, show melting temperature ranges under 300° C., which is desirable for nonwoven processing and binding fibers together. The PVOH sample substrates are both suitable for nonwoven processing, regardless of the difference in their basis weights. In addition, both PVOH Sample substrates in Table 1 have a crystallinity range that is suitable for a hard-surface cleaning wipe. If the crystallinity range for a substrate is too high (e.g. greater than 75% or greater than 80%) the substrate material will be too brittle and not resilient enough for hard surface cleaning applications.

TABLE 1

| | | DSC Results | | |
|---|---|---|---|---|
| Sample | TGA Result | Tg (° C.) | Tg (° C.) | Crystallinity % |
| PVOH, | Three zones, starting | 78 | 229 | 61 |
| 18 gsm | at ~250° C. | | | |
| PVOH, | Two zones, starting | 81 | 222 | 53 |
| 25 gsm | at ~300° C. | | | |

The nonwoven substrates may be packaged within any desired container system. Examples of such include, but are not limited to flex packs, cylinders, tubs, or other containers for storage and dispensing. The wipes may typically be pulled through an orifice such as typically provided with such containers, without fear of shredding or delamination of any included layers, due to the binder fibers holding the pulp fibers to the remainder of the nonwoven substrate.

In some embodiments, it may be desirable to provide the substrate with a lofted structure, so as to increase the bulk and thickness of the substrate, where such lofted characteristics may not otherwise be provided, particularly by synthetic fibers. Such lofting may be provided by any suitable technique that may increase the bulk and thickness of the layer, by adding lofted material thereto, which includes gaps, air pockets, and/or a fuzzy, lofted characteristic.

In an embodiment, the pulp fibers or other natural fibers may provide for relatively high extensibility to the substrate, particularly in the cross-direction, unless something is done to counteract such extensibility. In particular, in the present invention, the included synthetic binder fibers may aid in reducing this extensibility to within a desired range. A suitable range for extensibility for the substrates of the present invention, in the cross-direction, is between about 30% and 70%, or between about 40% and 60%. Such reduced extensibility may be achieved even where no calendaring operation is employed during manufacture of the nonwoven substrates to melt soften and bind the two different fiber materials together. For example, during such calendaring, as the synthetic thermoplastic fibers are heated, and undergo some degree of melting, they encapsulate or coat the adjacent pulp fibers, helping to hold them in place, and reducing the extensibility that would otherwise be exhibited. Even where no such calendaring may be employed specifically for bonding, e.g., where hydroentangling or a spunlace process is used to bind the fibers together, the binder fibers may similarly undergo some melting and subsequent bonding to adjacent pulp fibers as the molten or softened binder fibers cool, after being heated in a drying step of such a hydroentangling or spunlace process. This reduced extensibility can be important in providing overall desired hand-feel characteristics to the finished wipe.

### III. Cleaning Composition

Many cleaning composition components as known within the art may be suitable for use in the present pre-dosed wipes. In an embodiment, the cleaning composition is an aqueous composition, including at least 70%, at least 80%, or at least 90% water by weight (e.g., 90% to 99% water). The composition may include 0.05% to 5% by weight of a quaternary ammonium compound, and/or 0.1% to 5% by weight of a glycol ether solvent. For example, the quaternary ammonium compound may be included from 0.05%, from 0.1%, up to 5%, up to 4%, up to 3%, up to 2%, or up to 1% by weight of the cleaning composition. The glycol ether solvent may be included from 0.1%, from 0.25%, up to 5%, up to 4%, up to 3%, up to 2%, or up to 1% by weight of the cleaning composition. Other solvents, surfactants, and various other adjuvants often included in cleaning compositions may optionally be present. While some embodiments may include lower alcohol solvents (e.g., C₁-C₄ alcohols), the amount of such volatile solvents may be limited, e.g., to less than 10%, less than 5%, less than 3%, less than 2%, or less than 1% by weight. In some embodiments, the composition may be free of, or substantially free of, such lower alcohol or other highly volatile solvents.

Quaternary ammonium compounds have broad spectrum antimicrobial properties. A variety of different quaternary ammonium compounds can be used in the cleaning composition. Non-limiting examples of quaternary ammonium compounds are typically halides (e.g., a chloride) of alkyldimethylbenzylammonium, alkyldimethylethylbenzylammonium, alkyldimethylammonium, or the like. The alkyl groups of such quaternary ammonium compounds may typically range from C₁₂ to C₁₈. Quaternary ammonium compounds are described in more detail in U.S. Pat. No. 6,825,158, incorporated by reference herein, and will already be familiar to those of skill in the art.

Organic acids can also be used to provide antimicrobial properties. Suitable organic acids include but are not limited to, citric acid, lactic acid, glycolic acid, and any combinations thereof. By way of example, such an organic acid may be included in an amount of at least 0.1%, or at least 0.5%, up to 5%, up to 4%, up to 3%, up to 2%, or up to 1% by weight of the cleaning composition.

The cleaning composition may include a glycol ether solvent. Exemplary glycol ether solvents include, but are not limited to, ethylene glycol monopropyl ether, ethylene glycol monobutyl ether, propylene glycol n-propyl ether, propylene glycol monobutyl ether, propylene glycol t-butyl ether, diethylene glycol monoethyl or monopropyl or monobutyl ether, di- or tri-polypropylene glycol methyl or ethyl or propyl or butyl ether, acetate and/or propionate esters of glycol ethers.

Those of skill in the art will appreciate that any among a wide variety of surfactants (e.g., anionic, cationic, non-ionic, zwitterionic, and/or amphoteric) may be included in the cleaning composition, as desired. Where included, a surfactant may be present from 0.05%, from 0.1%, up to 10%, up to 5%, up to 4%, up to 3%, up to 2%, or up to 1% by weight of the cleaning composition. Various surfactants and other optional adjuvants are disclosed in U.S. Pat. No. 3,929,678 to Laughlin and Heuring, U.S. Pat. No. 4,259,217 to Murphy, U.S. Pat. No. 5,776,872 to Giret et al.; U.S. Pat. No. 5,883,059 to Furman et al.; U.S. Pat. No. 5,883,062 to Addison et al.; U.S. Pat. No. 5,906,973 to Ouzounis et al.; U.S. Pat. No. 4,565,647 to Llenado, and U.S. Publication No. 2013/0028990. The above patents and applications are each herein incorporated by reference in their entirety.

As used herein the term “liquid” and “cleaning composition” includes, but is not limited to, solutions, emulsions, suspensions and so forth. Thus, liquids may comprise and/or contain one or more of the following: disinfectants; antiseptics; diluents; surfactants, such as nonionic, anionic, cationic; waxes; antimicrobial agents; sterilants; sporicides; germicides; bactericides; fungicides; virucides; protozoacides; algicides; bacteriostats; fungistats; virustats; sanitizers; antibiotics; pesticides; and so forth. Examples of some such components are included in, but not limited to, U.S. Pat. Nos. 6,825,158; 8,648,027; 9,006,165; 9,234,165, 9,988,594, 10,421,929 and U.S. Publication No. 2008/003906, each of which is herein incorporated by reference in its entirety. In some embodiments, it may be possible to provide the substrates in dry form, where dosing with a selected cleaning composition may occur later (e.g., by the user). In another embodiment, the wipes may be dosed with a solid cleaning composition, where the user may add water to the wipes, at or shortly before the time of use, resulting in the dosed wipes, ready for use. Pre-dosed wipes may be preferred, e.g., as the amount and concentrations of the components in the cleaning composition can be more carefully controlled during manufacture, than may occur where the final composition may depend on the user for dilution or water addition.

With regard to pre-moistened substrates, a selected amount of liquid may be added to the container or wipes during manufacture such that the cleaning substrates contain the desired amount of liquid. The substrates are not necessarily loaded to their saturation point, but are typically loaded with the cleaning composition to some ratio less than full saturation. For example, many substrates are capable of holding about 8 to 14 times their weight in liquid. For various reasons, the substrates may be loaded at a loading ratio less than saturation, e.g., less than 6:1, less than 5:1, less than 4:1, such as from 1:1 to 4:1, from 2:1 to 4:1, from 2.5:1 to 3.5:1, from 2.5:1 to 3:1 or from 2.5:1 to 3.75:1.

It is important to understand and account for how the substrate materials affect the chemistry of the cleaning composition being dosed onto the wipes. For example, it can be important to avoid or minimize unwanted chemical interactions that may inadvertently deactivate the active agents within the cleaning composition. For example such may occur due to incompatibility between components included in the cleaning composition versus the substrate. By way of non-limiting example, a variety of bleaching agents (e.g., chlorine-based and otherwise, including peroxides) may be used with some substrates. Compositions which achieve disinfection based on acids may also be used. Care must often be taken to minimize or at least account for incompatibilities between such acid disinfectants and/or bleaches relative to substrate materials, particularly the pulp or any other non-synthetic substrate components. It is desirable that an effective amount of any given active agent not only be loaded into the wipe, but actually be released in the “squozate” from such wipe, during use. Non-limiting examples of cleaning compositions are disclosed in U.S. Pat. No. 5,460,833 to Andrews et al.; U.S. Pat. No. 6,221,823 to Crisanti; U.S. Pat. No. 6,346,279 to Rochon et al.; U.S. Pat. No. 6,551,980 to Wisniewski et al.; U.S. Pat. No. 6,699,825 to Rees et al.; U.S. Pat. No. 6,803,057 to Ramirez et al.; U.S. Pat. No. 6,812,196 to Rees et al.; U.S. Pat. No. 6,936,597 to Urban; U.S. Pat. No. 7,008,600 to Katsigras et al.; U.S. Pat. No. 7,070,737 to Bains et al.; U.S. Pat. No. 7,354,604 to Ramirez et al.; U.S. Pat. No. 7,598,214 to Cusack et al.; U.S. Pat. No. 7,605,096 to Tamarchio et al.; U.S. Pat. No. 7,658,953 to Bobbert; U.S. Pat. No. 7,696,143 to McCue et al.; U.S. Pat. No. 7,915,207 to Chopskie et al.; U.S. Pat. No. 8,569,220 to Gaudrealt; U.S. Pat. No. 8,575,084 to Gaudrealt; U.S. Pat. No. 10,064,409 to Hazenkamp et al.; U.S. Pat. No. 10,076,115 to Salminen et al.; U.S. Pat. No. 10,358,624 to Mitchell et al.; U.S. Publication No. 2007/0190172 to Bobbert; PCT Publication Nos. WO 99/18180 to Raso et al.; WO 99/53006 to Masotti et al.; WO 2004/067194 to Arrigoni et al.; WO 2004/104147 to Rosiello et al.; WO 2017/174959 to Convery; and EPO Publication EP 2843034 to Nedic et al., each of which is herein incorporated by reference in its entirety.

The size and shape of the wipe can vary with respect to the intended application and/or end use of the same. The cleaning substrate can have a substantially rectangular shape of a size that allows it to readily engage standard cleaning equipment or tools such as, for example, mop heads, duster heads, brush heads, mitten shaped tools for wiping or cleaning, and so forth. In another embodiment, another shape, e.g., circular, oval, or the like) may be provided.

The wipes or other cleaning substrates may be provided pre-moistened with a cleaning composition. The wet cleaning substrates can be maintained over time in a sealable container such as, for example, within a bucket or tub with an attachable lid, sealable bags, plastic pouches (e.g., “flex packs”), canisters, jars, and so forth. Desirably the wet, stacked cleaning substrates are maintained in a resealable container. The use of a resealable container is particularly desirable when using aqueous volatile liquid compositions since substantial amounts of liquid can evaporate while using the first sheets thereby leaving the remaining sheets with little or no liquid. Exemplary resealable containers and dispensers include, but are not limited to, those described in U.S. Pat. No. 4,171,047 to Doyle et al., U.S. Pat. No. 4,353,480 to McFadyen, U.S. Pat. No. 4,778,048 to Kaspar et al., U.S. Pat. No. 4,741,944 to Jackson et al., U.S. Pat. No. 5,595,786 to McBride et al.; the entire contents of each of the aforesaid references are incorporated herein by reference.

Typically, the cleaning substrates are stacked and placed in the container and the liquid subsequently added thereto, all during mass manufacturing. No matter the packaging and dosing process, once manufactured and packaged, the substrate can subsequently be used to wipe a surface. The moistened cleaning substrates can be used to treat various surfaces. As used herein “treating” surfaces is used in the broad sense and includes, but is not limited to, wiping, polishing, swabbing, cleaning, washing, disinfecting, scrubbing, scouring, sanitizing, and/or applying active agents thereto.

The wipes or other cleaning substrates of the present invention can be provided in a kit form, wherein a plurality of cleaning substrates and a cleaning tool are provided in a single package.

In addition to material composition and construction, wipe or other substrate dimensions can also be used to control dosing as well as provide ergonomic appeal. In one embodiment, substrate dimensions are from about 5½ inches to about 11 inches in length, and from about 5½ inches to about 11 inches in width to comfortably fit in a hand. The substrate can have dimensions such that the length and width differ by no more than about 2 inches. Larger substrates may be provided that can be used and then folded, either once or twice, so as to contain dirt within the inside of the fold and then the wipe can be re-used. Such larger substrates may have a length from about 5½ inches to about 13 inches and a width from about 10 inches to about 13 inches. Such substrates can be folded once or twice and still fit comfortably in the hand.

Exemplary multi-layer substrates can be tested for their ability to effectively deliver an antimicrobial quaternary ammonium compound (“quat”) or other active agent to a surface during simulated cleaning. By way of example, the substrates of the present invention may be loaded with cleaning compositions including from 0.1% to 3%, such as 0.1% to 2% by weight of the quaternary ammonium compound. In an embodiment, the wipes may release at least 40%, at least 50%, at least 55%, at least 60%, or at least 65% of the quaternary ammonium compound (i.e., quaternary ammonium compound in the squozate (i.e. the cleaning composition released from the substrate) as compared to the cleaning composition before loading). The wipes may exhibit at least a 3-log reduction in a target microbe, such as Staphylococcus aureus, within a given time frame (e.g., such as 5 minutes, 4 minutes, 3 minutes, 1 minute, 30 seconds, 10 seconds, etc.).

Without departing from the spirit and scope of this invention, one of ordinary skill can make various modifications to the invention to adapt it to various usages and conditions. As such, these changes and modifications are properly, equitably, and intended to be, within the full range of equivalence of the following claims.

1. A cleaning wipe comprising:
(a) a nonwoven substrate comprising natural fibers and synthetic thermoplastic binder fibers comprising at least one of a biodegradable or compostable polyester, polyvinyl alcohol (PVOH), or polyvinyl acetate (PVA); and
(b) a cleaning composition loaded onto said nonwoven substrate.

2. The wipe of claim 1, wherein the nonwoven substrate is produced utilizing at least one of the following manufacturing processes: meltblown, spunbond, spunlaid, SMS (spunbond-meltblown-spunbond), coformed, airlaid, wetlaid, carded web, thermal bonded, spunlace, hydroentangled, needled, chemically bonded, and combinations or mixtures thereof.

3. The wipe of claim 1, wherein the binder fibers comprise a polyhydroxyalkanoate (PHA) compostable polyester.

4. The wipe of claim 1, wherein the nonwoven substrate is substantially void of PLA.

5. The of claim 1, wherein the natural fibers comprise pulp fibers.

6. The wipe of claim 1, wherein the nonwoven substrate is formed from a blend of pulp fibers and at least one of PHA, PVOH, or PVA.

7. The wipe of claim 1, wherein the cleaning composition comprises a quaternary ammonium compound.

8. The wipe of claim 1, wherein the cleaning composition comprises at least one organic acid.

9. The wipe of claim 1, wherein the cleaning composition comprises an organic acid.

10. A cleaning wipe comprising:
(a) a nonwoven substrate comprising natural fibers and synthetic thermoplastic binder fibers comprising at least one of a biodegradable or compostable polyester, polyvinyl alcohol (PVOH), or polyvinyl acetate (PVA), wherein the nonwoven substrate is at least one of meltblown, spunbond, spunlaid, SMS (spunbond-meltblown-spunbond), coformed, carded web, thermal bonded, spunlace, hydroentangled, needled, or chemically bonded; and
(b) a cleaning composition comprising a quaternary ammonium compound, the cleaning composition being loaded onto said nonwoven substrate.

11. The wipe of claim 10, wherein the binder fibers comprise a polyhydroxyalkanoate (PHA) compostable polyester.

12. The wipe of claim 10, wherein the nonwoven substrate is substantially void of PLA.

13. The wipe of claim 10, wherein the natural fibers comprise pulp fibers.

14. The of claim 10, wherein the nonwoven substrate is formed from a blend of pulp fibers and at least one of PHA, PVOH, or PVA.

15. A cleaning wipe comprising:
(a) a nonwoven substrate comprising natural fibers and synthetic thermoplastic binder fibers comprising at least one of a biodegradable or compostable polyester, polyvinyl alcohol (PVOH), or polyvinyl acetate (PVA), wherein the nonwoven substrate is at least one of meltblown, spunbond, spunlaid, SMS (spunbond-meltblown-spunbond), coformed, carded web, thermal bonded, spunlace, hydroentangled, needled, or chemically bonded; and
(b) a cleaning composition comprising at least one organic acid, the cleaning composition being loaded onto said nonwoven substrate.

16. A pre-loaded wipe system packaged within a container, the system comprising:
(a) a plurality of nonwoven substrates comprising natural pulp fibers and synthetic thermoplastic binder fibers comprising at least one of polyhydroxyalkanoate (PHA), polyvinyl alcohol (PVOH), or polyvinyl acetate (PVA), wherein the nonwoven substrate is substantially void of PLA, wherein the nonwoven substrate is at least one of meltblown, spunbond, spunlaid, SMS (spunbond-meltblown-spunbond), coformed, airlaid, wetlaid, carded web, thermal bonded, thermoformed, spunlace, hydroentangled, needled, chemically bonded, or combinations thereof;
(b) a cleaning composition loaded onto said nonwoven substrate, the cleaning composition comprising:
i. 0.05-5% by weight of one or more antimicrobial compounds;
ii. 0.05-1% by weight of a surfactant;
iii. 0.1-5% by weight of at least one glycol ether or alcohol solvent; and
iv. at least 90% by weight of water; and
(c) a container within which the plurality of nonwoven substrates loaded with the cleaning composition are packaged.

17. The wipe of claim 16, wherein the nonwoven substrate is a multi-layer substrate and formed from a blend of pulp fibers and at least one of PHA, PVOH, or PVA.

18. The wipe of claim 16, wherein the antimicrobial compound is an organic acid.

19. The wipe of claim 16, wherein the antimicrobial compound is a quaternary ammonium compound.

20. The wipe of claim 16, wherein the solvent is an alcohol.
